(19) United States
(12) Patent Application Publication
(10) Pub. No.: US 2025/0128983 A1
(43) Pub. Date: Apr. 24, 2025

(54) PHOTOCURABLE INKS FOR AUTOMOTIVE INTERIOR APPLICATIONS AND GLASS ARTICLES COMPRISING THE SAME

(71) Applicant: CORNING INCORPORATED, CORNING, NY (US)

(72) Inventors: Carlos Francis Alonzo, Corning, NY (US); Aaron Bradley Gleason, Bath, NY (US); Mandakini Kanungo, Ithaca, NY (US); Manoj Meda, Painted Post, NY (US); Timothy Edward Myers, Painted Post, NY (US)

(21) Appl. No.: 18/730,601

(22) PCT Filed: Jan. 13, 2023
(86) PCT No.: PCT/US2023/010760

§ 371 Date: Jul. 19, 2024

Related U.S. Application Data
(60) Provisional application No. 63/393,532, filed on Jul. 29, 2022.
(60) Provisional application No. 63/304,732, filed on Jan. 31, 2022.

(51) Int. Cl. C03C 17/32; C09D 11/101; C09D 11/107; C09D 11/30; C09D 11/54

(52) U.S. Cl. CPC C03C 17/32; C09D 11/101; C09D 11/107; C09D 11/30; C09D 11/54; C03C 2217/732

(57) ABSTRACT

Described herein is a glass article comprising a glass substrate having a major surface and an opaque layer disposed on the major surface. The opaque layer comprises a photocurable ink that comprises at least 10 wt % of a pigment. The opaque layer comprises a thickness of less than or equal to 25 μm and an optical density of greater than or equal to 4.0. After curing via exposure to curing light from an ultraviolet light (“UV”) light emitting diode (“LED”), the opaque layer exhibits: (a) a pencil hardness of greater than or equal to 3H when measured according to ASTM 3363, and (b) an adhesion to the glass substrate of greater than or equal to 4B after being subjected to a temperature of 85° C. at 95% relative humidity for a period of at least 500 hours, when tested according to ASTM 3359.

### PRIORITY

This application claims the benefit of priority under 35 U.S.C. § 119 of U.S. Provisional Application Ser. No. 63/304,732 filed on Jan. 31, 2022, and U.S. Provisional Application Ser. No. 63/393,532 filed on Jul. 29, 2022, the contents of which are relied upon and incorporated herein by reference in their entirety.

### FIELD

The disclosure relates to photocurable inks for automotive interior display applications and glass articles comprising the same.

### BACKGROUND

Automotive interiors may include displays that include a display cover glass. A display module (e.g., a liquid crystal display (“LCD”) module, an organic light emitting diode (“OLED”) display module, or other suitable type of display module) may be laminated to or otherwise integrated with the cover glass such that the cover glass protects the display module and/or provides one or more performance enhancing attributes (e.g., anti-glare or anti-reflective properties) to the display module. A decorative ink may be applied to areas of the cover glass to conceal various components (e.g., electrical and mechanical connections) of the display and/or provide the display with a uniform appearance when the display is powered down. Certain existing inks used for decorating display cover glass may suffer from various deficiencies rendering these inks unsuitable for automotive interior applications. For example, some existing inks may be applied through a screen-printing process, which may require multiple layers to provide a desired optical density and have relatively low throughputs in production. Other existing inks (e.g., UV-curable inks) may fail to provide a desired optical density per unit thickness and/or provide adequate adhesion to the cover glass either initially or after being subjected to environmental testing associated with variable environmental conditions (e.g., in terms of temperature or humidity) that automotive interior components are exposed to. Accordingly, an alternative ink that meets requirements associated with automotive interior display applications is needed.

### SUMMARY

One embodiment relates to a glass article comprising: a glass substrate having a first major surface and a second major surface, the second major surface being opposite the first major surface; and an opaque layer disposed on the second major surface, the opaque layer comprising a photocurable ink comprising at least 10 wt % of a pigment, wherein: the opaque layer comprises a thickness of less than or equal to 25 μm and an optical density of greater than or equal to 4.0, and after curing via exposure to curing light from an ultraviolet light (“UV”) light emitting diode (“LED”), the opaque layer exhibits: a pencil hardness of greater than or equal to 3H when measured according to ASTM 3363, and an adhesion to the glass substrate of greater than or equal to 4B after being subjected to a temperature of 85° C. at 95% relative humidity for a period of at least 500 hours, when tested according to ASTM 3359.

Another embodiment includes a display for a vehicle interior system, the display comprising: a glass substrate having a first major surface and a second major surface, the second major surface being opposite the first major surface; an opaque layer disposed on the second major surface, the opaque layer comprising a photocurable ink comprising at least 10 wt % of a pigment; and a display panel disposed on the second major surface, wherein: the opaque layer is disposed at a peripheral region of the second major surface and extends over an edge of the display panel, the opaque layer comprises a thickness of less than or equal to 25 μm and an optical density of greater than or equal to 4.0, and after curing via exposure to curing light from an ultraviolet light (“UV”) light emitting diode (“LED”), the opaque layer exhibits: a pencil hardness of greater than or equal to 3H when measured according to ASTM 3363, and an adhesion to the glass substrate of greater than or equal to 4B when subjected to a temperature of 85° C. at 95% relative humidity for a period of at least 500 hours, when tested according to ASTM 3359.

Another embodiment relates to a method of fabricating a glass article, the method comprising: depositing a photocurable ink onto a major surface of a glass substrate at a deposition temperature that is less than or equal to 65° C. using an inkjet printhead, wherein during the depositing, the photocurable ink has a viscosity of less than 25 cP, wherein the photocurable ink comprises at least 10 wt % of a pigment and at least 50 wt % reactive monomer, and curing the photocurable ink on the major surface by exposing the photocurable ink to curing light generated by a ultraviolet light (“UV”) light emitting diode (“LED”) to form an opaque layer, wherein the curing light has a bandwidth of less than or equal to 30 nm, wherein: the opaque layer comprises a thickness of less than or equal to 25 μm and an optical density of greater than or equal to 4.0, and the opaque layer exhibits: a pencil hardness of greater than or equal to 3H when measured according to ASTM 3363, and an adhesion to the glass substrate of greater than or equal to 4B when subjected to a temperature of 85° C. at 95% relative humidity for a period of at least 500 hours, when tested according to ASTM 3359.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a vehicle interior with vehicle interior systems having displays, according to one or more embodiments of the present disclosure;

FIG. 2 schematically depicts a cross-sectional view of a display of a vehicle interior system through the line 2-2 depicted in FIG. 1, according to one or more embodiments of the present disclosure;

FIG. 3 depicts a flow diagram of a method of forming a glass article with an opaque layer, according to one or more embodiments of the present disclosure;

FIG. 4 depicts a plot of measured optical density as a function of opaque layer thickness for Examples 1-3, according to one or more embodiments of the present disclosure;

FIG. 5 depicts a photo of a sample formed according to the Example 2 after being subjected to a cross-hatch adhesion test, according to one or more embodiments of the present disclosure;

FIG. 6A depicts a photo of a sample coated with a first commercially available UV-curable ink after being subjected to testing at high temperature and humidity, according to one or more embodiments of the present disclosure; and

FIG. 6B depicts a photo of a sample coated with a second commercially available UV-curable ink after being subjected to testing at high temperature and humidity, according to one or more embodiments of the present disclosure;

FIG. 7 is a plot showing the optical densities of the samples as a function of opaque layer thickness formed according to Example 5, according to one or more embodiments of the present disclosure; and

FIG. 8 depicts a photo of a sample formed according to the Example 5 after being subjected to a cross-hatch adhesion test, according to one or more embodiments of the present disclosure.

### DETAILED DESCRIPTION

Referring generally to the figures, described herein are photocurable inks that may be used to form opaque layers on display cover glass with high-throughput curing processes. Once the photocurable ink is cured, the opaque layer may have a relatively high adhesion to glass and high optical density per unit thickness, while excluding certain solvents that tend have environmentally harmful effects. In embodiments, for example, the photocurable inks described herein are capable of being cured into opaque layers with thicknesses of less than 25 μm (e.g., less than or equal to 20 μm, less than or equal to 15 μm, less than or equal to 10 μm) while providing an optical density of greater than or equal to 4 (e.g., greater than or equal to 5). The photocurable inks may also be curable using a light emitting diode (“LED”) light source having a relatively narrow ultraviolet (“UV”) spectral output (e.g., 365±10 nm, 385±10 nm, 395±10 nm, 405±10 nm), facilitating production efficiencies. Moreover, the photocurable inks described herein may also be compatible with commercially available inkjet printing processes (e.g., have an un-cured viscosity of less than 25 cP at temperatures less than or equal to 60° C.) to facilitate relatively low-cost, high throughout production processes. The photocurable inks described herein may provide each of the aforementioned beneficial properties all while exhibiting reliable adhesion to cover glass when subjected to environmental testing. Certain ink compositions according to the present disclosure may exhibit an adhesion to the cover glass of greater than or equal to 4B when subjected to a cross-hatch tape test in accordance with ASTM 3359, hereby incorporated by reference in its entirety.

In embodiments, the photocurable inks of the present disclosure comprise a pigment dispersion, an optional adhesion promoter, a binder solution, a multifunctional monomer and a photo initiator package. The pigment dispersion comprises 20 wt % to 50 wt % of a suitable pigment (e.g., a carbon black pigment) or suitable mixture of pigments and 50 to 80 wt % of a first reactive monomer (e.g., a suitable acrylate monomer such as neopentyl glycol diacrylate or trimethylolpropane triacrylate). The pigment may account for greater than or equal to 10 wt % (e.g., greater than or equal to 20 wt %) of the ink composition to facilitate the ink comprising a relatively high optical density (e.g., greater than or equal to 4, greater than or equal to 5) at relatively low thicknesses (e.g., less than or equal to 25 μm post curing). The first reactive monomer may be present in an amount that is greater than or equal to 40 wt % and less than or equal to 60% of the photocurable ink composition. The adhesion promoter, when included, may account for between 10 wt % and 20 wt % of the ink composition and comprise a monofunctional monomer for enhancing adhesion to the cover glass. For example, the adhesion promoter may comprise a 2-hydroxyethyl acrylate (2-HEA) monomer. The binder solution may comprise a suitable epoxy resin to adjust the adhesion and surface hardness of the cured opaque layer. The epoxy resin may account for less than 5 wt % of the ink composition. In embodiments, the binder solution, in addition to the epoxy resin, comprises a suitable acrylate monomer as a reactive diluent. The photocurable ink may also comprise a multifunctional monomer to achieve relatively high cross-linking density (e.g., to facilitate high surface hardness). The photoinitiator package may include one or more suitable photoinitiators to facilitate curing using a UV LED. In embodiments, the photoinitiator package comprises a Norrish Type I photoinitiator and a Norrish Type II initiator to induce rapid photo-polymerization of the ink composition. A combined wt % of the photoinitiators of the package may comprise up to 10 wt % of the ink composition. In embodiments, the Type I photoinitiator comprises a concentration that is greater than twice that of the Type II photoinitiator to facilitate photopolymerization. The photocurable inks of the present disclosure may also include less than 0.5 wt % (e.g., less than 0.1 wt %) of a suitable polymerization inhibitor to facilitate transport and storage.

The photocurable inks of the present disclosure may also satisfy various environmental compliance standards. For example, in embodiments, the photocurable inks described herein contain less than 10 wt % volatile organic compounds, thus satisfying GB 35807-2020, entitled “Limits of Volatile Organic Compounds (VOCs) in Printing Ink,” hereby incorporated by reference in its entirety. Moreover, the photocurable inks of the present disclosure may be free of halogenated hydrocarbon and free of the solvents identified by CAS Registry Number in Table 1.

TABLE 1

| | Component | CAS |
|---|---|---|
| 1 | Ethylbenzene | 100-41-4 |
| 2 | Propylene oxide (Oxirane, methyl-) | 75-56-9 |
| 3 | Styrene (Benzene, ethenyl-) | 100-42-5 |
| 4 | benzene | 71-43-2 |
| 5 | Isopropyl nitrite | 541-42-4 |
| 6 | Butyl nitrite | 544-16-1 |
| 7 | Ethylene glycol monoethyl ether (2-Ethoxyethanol) | 110-80-5 |
| 8 | Ethylene glycol ether acetate | 111-15-9 |
| 9 | Ethylene glycol monomethyl ether (2-Methoxyethanol) | 109-86-4 |
| 10 | Ethylene glycol formaldehyde acetate | 110-49-6 |
| | (2-Methoxyethyl Acetate.) | |
| 11 | 2-nitropropane | 79-46-9 |
| 12 | N-methyl-2-pyrrolidone | 872-50-4 |
| 13 | Triethylene glycol dimethyl ether | 112-49-2 |
| 14 | Ethylene glycol dimethyl ether | 110-71-4 |
| 15 | Ethylene glycol diethyl ether | 629-14-1 |
| 16 | Toluene | 108-88-3 |
| 17 | Xylene | 1330-20-7 |

Such solvents are known have potentially harmful effects on the environment and/or human health. Certain existing photocurable inks incorporate the solvents listed in Table 1 in order to provide UV-curable inks with relatively high optical densities that are compatible with inkjet printing. The photocurable inks of the present disclosure provide such favorable attributes without such harmful solvents. The photocurable inks of the present disclosure provide un-cured viscosities suitable for inkjet printing without the addition of harmful solvents, and thus facilitate relatively high throughput (e.g., greater than 20 m²/hour, greater than 30 m²/hour, greater than 40 m²/hour, greater than 50 m²/hour) printing process with commercially available printheads. Inkjet printing processes are beneficially compatible with chemically strengthened cover glass, unlike certain other inks based on ceramic frits that require relatively high curing temperatures.

In embodiments, the compositions of the photocurable inks described herein may be tailored to meet particular appearance requirements associated with design needs. For example, a cover glass comprising an opaque layer constructed of the photocurable inks described herein may meet any of the black mask color targets in Table 2.

TABLE 2

| | CM700D (CIE D65, 10°) Measurement through bare glass | | | | | |
|---|---|---|---|---|---|---|
| | SCI | | | SCE | | |
| Ink Type | L* | a* | b* | L* | a* | b* |
| Black Mask | 25.0 | 0.05 | −0.2 | <1 | 0 | 0 |
| Black Mask | 25.3 | | | | | |
| Black Mask | 25.7 | | | | | |
| Black Mask | 25.9 | | | | | |
| Black Mask | 26.0 | | | | | |
| Black Mask | 26.8 | | | | | |
| Black Mask | 27.4 | | | | | |
| Black Mask | 27.7 | | | | | |
| Black Mask | 28.3 | | | | | |
| Black Mask | 28.5 | | | | | |
| Black Mask | 30.1 | | | | | |

In embodiments, opaque layers constructed using the photocurable inks described herein may meet any of the combinations of values contained in the Table 2 within the tolerances outlined in the Table 3 below.

TABLE 3

| OD | ΔE within the part | L* Tol | a* Tol | b* Tol |
|---|---|---|---|---|
| ≥4 | 0.6 | ±0.10 | ±0.10 | ±0.10 |

As demonstrated by the Tables 2-3, cover glass incorporating the photocurable inks described herein, when viewed from an uncoated surface of the cover glass (e.g., from a side of the glass opposite to that on which a display disposed) may generally have CIELAB L* values that are less than or equal to 30 (less than or equal to 29, less than or equal to 28, less than or equal to 27, less than or equal to 25, less than or equal to 25), CIELAB a* values (specular component included) that are greater than or equal to −0.05 and less than or equal to 0.15, and CIELAB b* values (specular component included) that are less than or equal to −0.1 and greater than or equal to −0.3, when illuminated with a CIE D65 illuminant at a 10° angle of incidence. When the specular component is excluded, the cover glass may exhibit CIE L* values that are less than or equal to 1, and CIELAB a* and b* values with magnitudes that are less than or equal to 0.1. Areas of the cover glass coated with the photocurable inks described herein may exhibit dark, neutral appearances to facilitate concealing various components from view.

The photocurable inks of the present disclosure may also be used to construct opaque layers on cover glass that exhibit favorable reliability testing results when compared to certain existing photocurable inks. Automotive interior components are subjected to environmental conditions that are highly variable (e.g., in terms of temperature and relative humidity). In embodiments, opaque layers may meet one or more of the following criteria when subjected to the reliability testing outlined in Table 4.

TABLE 4

| | | Acceptance | | Sample |
|---|---|---|---|---|
| Test | Test Method/Conditions/Tool | Criteria | | Size |
| A - Damp | 1. Test Condition | 1. | Delta E (before/after test) | 2 |
| Heat, Cyclic | \textcircled{1} Preconditioning: 55° C. ± 2° C. with a relative humidity | | <2 | |
| (with Frost) | not exceeding 20% for a period of 24 h prior to the first | 2. | Ink adhesion ≥ 4B | |
| | cycle of the damp heat test. | | | |
| | \textcircled{2} Cycles 1-5: include cold phase | | | |
| | a) 0-1.5 hr: raise to 25° C. ± 2° C., 93 ± 3% | | | |
| | b) 1.5-2.5 hr: raise to 65° C. ± 2° C., 93 ± 3% | | | |
| | c) 2.5-5.5 hr: keep at 65° C. ± 2° C., 93 ± 3% | | | |
| | d) 5.5~7/8 hr: decrease to 25° C. ± 2° C., 80~96% | | | |
| | e) 8~9.5/10.5 hr: raise to 65° C. ± 2° C., 93 ± 3% | | | |
| | f) ~9.5/10.5-13.5 hr: keep at 65° C. ± 2° C., 93 ± 3% | | | |
| | g) 13.5~15/16 hr: decrease to 25° C. ± 2° C., 80~96% | | | |
| | h) ~15/16-17.5 hr: keep at 25° C. ± 2° C., 93 ± 3% | | | |
| | i) 17.5~18 hr: decrease to −10° C. ± 2° C., uncontrolled % | | | |
| | j) 18-21 hr: keep at −10° C. ± 2° C., uncontrolled % | | | |
| | k) 21-22.5 hr: raise to 25° C. ± 2° C., uncontrolled % | | | |
| | l) 22.5-24 hr: keep at 25° C. ± 2° C., 93 ± 3% | | | |
| | \textcircled{3} Cycles 6-10: without a cold phase | | | |
| | a) \textcircled{2} a)-g) | | | |
| | b) 15/16-24 hr: keep at 25° C. ± 2° C., 93 ± 3% | | | |
| | 2) Total cycles: 10 (5 + 5) | | | |
| B.1 - High | 65° C./95% RH, 500 hrs | 1. | Delta E (before/after test) | 2 |
| Temp/High | | | <2 | |
| Humidity | | 2. | Ink adhesion ≥ 4B | |
| B.2 - High | 85° C./95% RH, 500 hrs | 3. | Delta E (before/after test) | 2 |
| Temp/High | | | <2 | |
| Humidity | | 1. | Ink adhesion ≥ 4B | |
| C - High | 95° C., 500 hrs | 2. | Delta E (before/after test) | 2 |
| Temp. | | | <2 | |
| | | 3. | Ink adhesion ≥ 4B | |
| D - Low | −40° C., 500 hrs | 1. | Delta E (before/after test) | 2 |
| Temp. | | | <2 | |
| | | 2. | Ink adhesion ≥ 4B | |
| E - Chemical | Test temp.: TRT (23° C.); | 1. | No crack/bleach/color | 2 |
| Resistance | Test duration: 2 Hr, | | change allowed | |
| | Method: Wet a cotton cloth (30*30 mm) with 50 ml respective | 2. | Delta E (before/after test) | |
| | chemical agent (e.g., ammonia base cleaner, antifreeze, soda, citric | | <2 | |
| | acid, electric grease connector, nail polish remover, hand cleaner, | | | |
| | hand lotion, battery liquid); Wet the DUT with this cotton cloth until | | | |
| | it is completely wet, let redundant agent drip off the DUT | | | |
| D - Salty | Salty Water Chamber: 5% NaCl, 35° C. for 72 hrs −> water | 1. | Delta E (before/after test) | 2 |
| Water | cleaning −> drying | | <2 | |
| | | 2. | Ink adhesion ≥ 4B | |
| F - Cross | ASTM 3359 | 1. | Ink deterioration such as | 2 |
| Hatch Tape | | | flaking, peeling, cracking | |
| Test | | | or blistering: not allowed | |
| | | 2. | Ink adhesion ≥ 4B | |
| G - Solar | 1. Test condition | 1. | Delta E (before/after test) | 2 |
| Radiation | 1) Z-IN1 profile of DIN 75220 | | <2 | |
| Test | \textcircled{1} dry air (15 days) | 2. | Ink adhesion ≥ 4B | |
| | chamber temp: +80 ± 3° C. | 3. | No cracking allowed | |
| | relative humidity: <30 | | | |
| | Irradiance: 830 ± 80 [W/m2] | | | |
| | \textcircled{2} humid climate (10 days) | | | |
| | chamber temp: +80 ± 3° C. | | | |
| | relative humidity: >40 | | | |
| | Irradiance: 830 ± 80 [W/m2] | | | |
| | 2) Test duration: 25days (15 days dry test, 10 days | | | |
| | humid climate test) | | | |
| H - Thermal | Thermal Shock Test Machine −40° C. (0.5 hr) ~95° C. | 1. | Delta E (before/after test) | 2 |
| Shock Test | (0.5 hr), 500 cycles | | <2 | |
| | | 2. | Ink adhesion ≥ 4B | |

An investigation has revealed that certain existing UV-curable inkjet compatible inks crack or otherwise fail when subjected to such testing conditions, rendering these inks unsuitable for certain automotive interior applications. For example, certain existing inks have been found to shrink and/or crack when subjected to Test B contained in the Table 4 above, while the photocurable inks described herein meet the testing criteria contained in the Table 4.

In addition to meeting the aforementioned reliability testing requirements, the photocurable inks described herein may meet the additional requirements provided in Table 5 to render them suitable for use with certain commercially available inkjet printers.

TABLE 5

| | |
|---|---|
| Ave. Pigment Particle size (nm) | <200, might be <50 to |
| | achieve L* target |
| Liquid Surface Tension (dynes/cm) | 25-35 |
| Cured Surface Tension (dynes/cm) | >36 |
| Electrical Resistivity (Ω/sq) | ≥1 × 10 \hat{ }9 Ω/sq |
| | ASTM D-257, 100VDC. |

The photocurable inks described herein may also exhibit a pencil hardness of greater than or equal to 3H when measured according to ASTM 3363, entitled “Standard Test Method for Film Hardness by Pencil Test,” hereby incorporated by reference in its entirety, with a 750 g weight and the pencil at a 45° angle, after curing with a narrowband UV LED light source emitting narrowband (e.g., less than or equal to 20 nm bandwidth, less than or equal to 30 nm bandwidth) curing light. Use of such UV LEDs saves space, cost, and is less environmentally harmful when compared with certain existing UV curing lamps. Certain existing UV-curing inks may not sufficiently cure to have such a pencil harness due when meeting the optical density requirements described herein due to opacity of the ink inhibiting curing. The photoinitiators of the inks described herein are selected to facilitate curing using UV LEDs, while still meeting the pencil hardness and optical density requirements described herein.

As such, the photocurable inks described herein are able to provide relatively high optical density per unit thickness to facilitate efficacy as a black matrix layer in a display, while being compatible with high throughput inkjet printing process and also meeting stringent reliability testing requirements associated with automotive interior displays. The photocurable inks described herein save fabrication costs for display cover glass while still providing highly reliable opaque layers demonstrated to provide consistent color performance over the lifetime of the component.

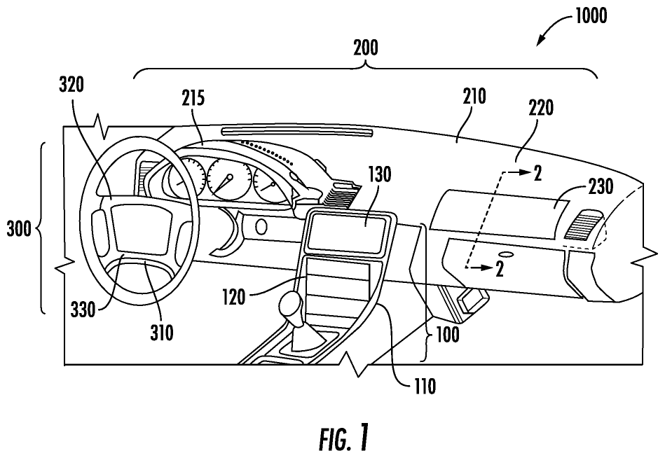

FIG. 1 shows a vehicle interior 1000 that includes three different vehicle interior systems 100, 200, 300, according to an exemplary embodiment. Vehicle interior system 100 includes a center console base 110 with a curved surface 120 including a display 230. Vehicle interior system 200 includes a dashboard base 210 with a curved surface 220 including a display 230. The dashboard base 210 typically includes an instrument panel 215 which may also include a curved display. Vehicle interior system 300 includes a dashboard steering wheelbase 310 with a curved surface 320 and a display 330. In one or more embodiments, the vehicle interior system may include a base that is an arm rest, a pillar, a seat back, a floorboard, a headrest, a door panel, or any portion of the interior of a vehicle that includes a curved surface. In embodiments, the displays 130, 230, 330 are flat and comprise cover glass with planar major surfaces. In embodiments, one or more of the displays 130, 230, 330 are curved, and the curved display may include curved cover glass that may be hot-formed or cold-formed to possess such curvature. For example, such embodiments may incorporate opaque layers formed of the photocurable inks described herein disposed on cold-formed glass substrates. Such cold-forming may involve any of the techniques described in U.S. Pre-Grant Publication No. 2019/0329531 A1, entitled “Laminating thin strengthened glass to curved molded plastic surface for decorative and display cover application,” U.S. Pre-Grant Publication No. 2019/0315648 A1, entitled “Cold-formed glass article and assembly process thereof,” U.S. Pre-Grant Publication No. 2019/0012033 A1, entitled “Vehicle interior systems having a curved cover glass and a display or touch panel and methods for forming the same,” and U.S. patent application Ser. No. 17/214,124, entitled “Curved glass constructions and methods for forming same,” which are hereby incorporated by reference in their entireties.

The embodiments of the glass articles described herein can be used in any or all of vehicle interior systems 100, 200 and 300. While FIG. 1 shows an automobile interior, the various embodiments of the vehicle interior system may be incorporated into any type of vehicle such as trains, automobiles (e.g., cars, trucks, buses and the like), seacraft (boats, ships, submarines, and the like), and aircraft (e.g., drones, airplanes, jets, helicopters and the like), including both human-piloted vehicles, semi-autonomous vehicles and fully autonomous vehicles. Further, while the description herein relates primarily to the use of the glass articles in vehicle displays, it should be understood that various embodiments discussed herein may be used in any type of display application.

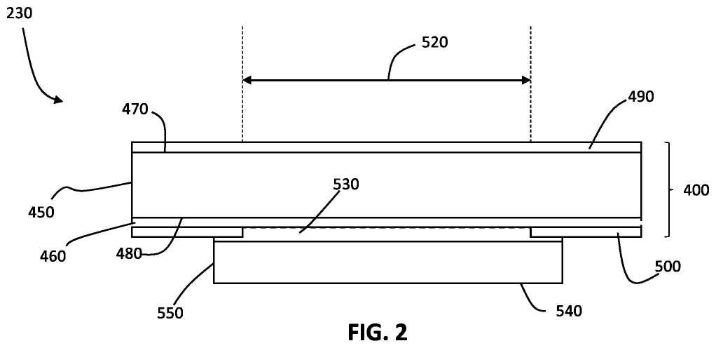

FIG. 2 schematically depicts a cross-sectional view of the display 230 through the line 2-2 of FIG. 1, according to an example embodiment where the display 230 is flat. While FIG. 2 depicts an example of the display 230, it should be understood that the displays 130, 330 described herein with respect to FIG. 1 may have similar cross-sectional structures and incorporate the photocurable inks described herein in a similar manner. While the display 230 is flat in the embodiment depicted in FIG. 2, embodiments are also envisioned where the display 230 is curved and the glass article 400 comprises one or more curved surfaces (e.g, as a result of being cold-formed or hot-formed to have a suitable curved shape).

As shown in FIG. 2, the glass article 400 comprises at least a substrate 450 and an opaque layer 500, and optionally includes a light management layer 460. The substrate 450 has a first surface 470 facing a viewer and a second surface 480 upon which the opaque layer 500 is, at least in part, disposed. As used herein, the term “dispose” includes coating, depositing and/or forming a material onto a surface using any known method in the art. The disposed material may constitute a layer, as defined herein. As used herein, the phrase “disposed on” includes the instance of forming a material onto a surface such that the material is in direct contact with the surface and also includes the instance where the material is formed on a surface, with one or more intervening material(s) is between the disposed material and the surface. The intervening material(s) may constitute a layer, as defined herein. The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

In embodiments, the substrate 450 is a glass substrate that is optionally chemically strengthened and comprises a thickness of from 0.05 to 2.0 mm. In one or more embodiments, the substrate 450 may be a transparent plastic, such as PMMA, polycarbonate and the like, or may be a glass material (which may be optionally strengthened). As will also be discussed more fully below, in embodiments, the opaque layer 500 is printed onto the second surface 480 of the substrate 450. In embodiments, the opaque layer 500 is printed onto the light management layer 460, when included. Certain existing UV-curable inks have been demonstrated to meet at least some of the requirements described herein with respect to Tables 1-4, but have been shown to be incompatible (e.g., lack the requisite adhesion) with the light management layer 460. For example, existing photocurable inks, when used for the opaque layer, may chemically react with the ink of the light management layer 460 (either upon deposition or after environmental testing) to change the characteristics (e.g., color, size) of the ink layers. Existing photocurable inks may also diffuse into the light management layer 460 and degrade performance thereof. The photocurable inks described herein, when used to form the opaque layer 500 and printed on the light management layer 460, do not suffer from such deficiencies and still provide adequate adhesion to the substrate 450 even when the light management layer 460 is present.

In embodiments, the glass article 400 comprises a functional surface layer 490. The functional surface layer 490 can be configured to provide one or more of a variety of functions. For example, the functional surface layer 490 may be optical coating configured to provide easy-to-clean performance, anti-glare properties, antireflection properties, and/or half-mirror coating. Such optical coatings can be created using single layers or multiple layers. In the case of anti-reflection functional surface layers, such layers may be formed using multiple layers having alternating high refractive index and low refractive index. Non-limiting examples of low refractive index films include SiO₂, MgF₂, and Al₂O₃, and non-limiting examples of high refractive index films include Nb₂O₅, TiO₂, ZrO₂, HfO₂, and Y₂O₃. In embodiments, the total thickness of such an optical coating (which may be disposed over an anti-glare surface or a smooth substrate surface) is from 5 nm to 750 nm. Additionally, in embodiments, the functional surface layer 490 that provides easy-to-clean performance also provides enhanced feel for touch screens and/or coating/treatments to reduce fingerprints. In some embodiments, functional surface layer 490 is integral to the first surface of the substrate. For example, such functional surface layers can include an etched surface in the first surface of the substrate 450 providing an anti-glare surface (or haze of from, e.g., 2% to 20%).

In embodiments, the opaque layer 500 is constructed of one or more of the photocurable inks described herein. Accordingly, the opaque layer 500 may comprise a relatively high optical density, e.g., an optical density of greater than 4, in order to block light transmittance. In embodiments, the opaque layer 500 is used to block light from transmitting trough certain regions of the glass article 400. In embodiments, the opaque layer 500 obscures functional or non-decorative elements provided for the operation of the glass article 400. In embodiments, the opaque layer 500 is provided to outline backlit icons and/or other graphics (not depicted) so as to increase the contrast at the edges of such icons and/or graphics. The opaque layer 500 can be any color; in particular embodiments, though, the opaque layer 500 is black or gray. In embodiments, the opaque layer 500 is applied via inkjet printing over the light management layer 460 and/or over the second surface 480 of the substrate 450. Generally, the thickness of the opaque layer 500 is less than or equal to 25 μm (e.g., greater than or equal to 1.0 μm and less than or equal to 25.0 μm, greater than or equal to 5.0 μm and less than or equal to 25.0 μm, greater than or equal to 5.0 μm and less than or equal to 20.0 μm, greater than or equal to 5.0 μm and less than or equal to 10.0 μm).

In embodiments, the opaque layer 500 may be directly deposited onto the second surface 480 of the substrate 450 using a suitable inkjet process. In embodiments, prior to deposition of the opaque layer 500, the second surface 480 may be primed using a suitable primer (e.g., an acryloxy silane primer) to facilitate adhesion of the opaque layer 500 to the substrate 450. Any suitable treatment to the second surface 480 may be used to facilitate adhesion of the opaque layer 500 to the substrate 450.

In embodiments, as shown in FIG. 2, the glass article 400 is placed over or in front of a display 540. In one or more embodiments, the display 540 may include a touch-enabled displays which include a display and touch panel. Exemplary displays include LED display, a DLP MEMS chip, LCDs, OLEDs, transmissive displays, and the like. The glass article 400 may generally have an average transmittance from 380 nm to 750 nm that is greater than or equal to 10% (e.g., greater than or equal to 20%, greater than or equal to 30%, greater than or equal to 40%, greater than or equal to 50%, greater than or equal to 60%, greater than or equal to 70%). The high optical density of the opaque layer 500, however, causes the areas of the glass article 400 incorporating the opaque layer 500 to have relatively low optical transmission (e.g., an average transmittance of less than or equal to 0.1% in the visible spectrum). Accordingly, the boundaries of the opaque layer 500 may define a display region 520 where the glass article 400 exhibits a relatively high optical transmission to facilitate visibility of images generated by the display 540.

In the depicted embodiment, the opaque layer 500 covers the edges 550 of the display 540 to hide the edges 550 from view through the first surface 470. The opaque layer 500 may also be used to obscure various other components from view (e.g., electrical connections, mechanical housings, and the like). The opaque layer 500 generally facilitates a desired portion of the display 540 being viewable by users viewing the first surface 470.

Referring still to FIG. 2, the light management layer 460, when included, may be printed on the substrate 450. In embodiments, the light management layer 460 is formed from a suitable thermal or UV cured ink. The light management layer 460 may generally reduce the optical transmission of the glass article 400 such that the glass article 400 exhibits a similar appearance to users irrespective of whether the display 540 is powered on or off. For example, the light management layer 460 may obscure edges of the display region 520, rendering the boundaries of the display region 520 inconspicuous to viewers when the display is powered off. The light management layer 460 may generally be constructed as described in any of International Patent Application Publication Nos. WO 2019/055458 A1, entitled “Black Deadfront for Display Device and Methods,” WO 2020/205519 A1, entitled “Decorated Glass Having a Printed Ink Layer,” or WO 2021/118835 A1, entitled, “Display Devices and Articles with Color-Matched Display and Non-Display Areas,” each of which are hereby incorporated by reference in their entirety.

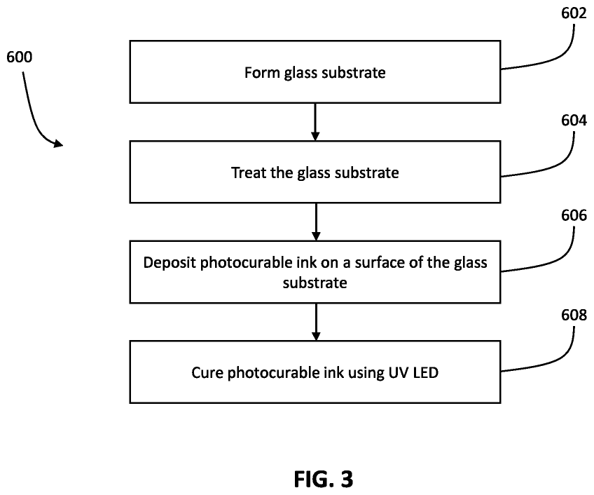

FIG. 3 depicts a flow diagram of a method 600 of forming a glass article with an opaque layer, according to one or more embodiments of the present disclosure. The method 600 may be performed to fabricate the glass article 400 described herein with respect to FIG. 2. Accordingly, reference will be made to various components described with respect to FIG. 2 to aid in the description of the method. It should be understood that other glass articles may be formed via performance of the method 600 and that the method 600 is not limited to a particular number or order of process steps.

At block 602, the substrate 450 is fabricated. Any suitable glass production process, such as a fusion down draw process, a float process, or the like may be used. Additional details regarding glass forming methods are provided herein. At block 604, the substrate 450 is treated. For example, in embodiments, the substrate 450 is subjected to a strengthening treatment (e.g., ion exchange strengthening, thermal strengthening). Additional details regarding strengthening treatments that may be provided to the substrate 450 are provided herein.

In embodiments, the treatments applied to the substrate 450 during the block 602 may be used to form the functional surface layer 490. For example, in embodiments, substrate 450 is chemically etched such that at least the first surface 470 exhibits anti-glare properties. A suitable anti-reflective coating and/or ETC coating may also be deposited onto the first surface 470 via a suitable deposition process. In embodiments, the second surface 480 may be primed (e.g., using a suitable chemical primer or ink) to facilitate adhesion of the opaque layer 500 thereto. In embodiments, the light management layer 460 may be deposited and cured onto the second surface 480 (e.g., a suitable ink may be cured thermally or via exposure to electromagnetic radiation).

At block 606, a photocurable ink is deposited onto the second surface 480 to initiate forming the opaque layer 500. As described herein, a suitable inkjet printing device may be used to deposit droplets of a suitable size onto the second surface 480 such that the photocurable ink forms a suitable pattern. Various parameters used to operate the inkjet printing device (e.g, control waveform, translation rate, deposition temperature) may vary depending on the composition of the photocurable ink and desired deposition pattern. At block 608, the photocurable ink is cured on the second surface 480 via exposure to electromagnetic radiation generated by a UV LED. In embodiments, the UV LED emits radiation having a relatively narrow bandwidth (e.g., less than or equal to 50 nm, less than or equal to 40 nm, less than or equal to 30 nm, less than or equal to 20 nm) surrounding a center UV wavelength (e.g., 375 nm, 380 nm, 385 nm, 390 nm, 395 nm, 400 nm). Operational parameters of the UV LED (e.g, output intensity, exposure period) may vary depending on various aspects of the opaque layer 500 (e.g., thickness, composition).

In embodiments, the blocks 606 and 608 may be performed while the substrate 450 comprises a planar shape. In embodiments, the blocks 606 and 608 are performed while the substrate is in a curved shape. For example, after application of at least some of the treatments described with respect to the block 604, the substrate 450 may be cold-formed via the methods described herein, and the opaque layer 500 may be formed on a cold-formed glass substrate. In embodiments, a suitable display panel is laminated to the glass article such that the opaque layer 500 at least partially covers the display panel.

### EXAMPLES

Embodiments of the present disclosure may be further understood in view of the following examples.

### Examples 1-3

Photocurable inks having different compositions were formulated. Additive carbon black dispersions were used in pigment dispersions of each of the inks. The concentration of the pigment was between 10 wt % and 20 wt % of each of the photocurable inks. In Example 1, a pigment dispersion containing a carbon black pigment from Penn Color, Inc. was used that included propoxylated neopentyl glycol diacrylate (PO-PPGDA) as the monomer. The carbon black pigment consisted of 10 wt % of the photocurable ink. In Example 2, a pigment dispersion containing a carbon black pigment from Penn Color, Inc. was used that included trimethylolpropane triacrylate (TMPTA) as the monomer. The carbon black pigment consisted of 20 wt % of the photocurable ink. In Example 3, a pigment dispersion containing a carbon black pigment from Sun Chemical® was used that included propoxylated neopentyl glycol diacrylate (PO-PPGDA) as the monomer. The carbon black pigment consisted of 10 wt % of the photocurable ink. The inks were jetted onto a chemically strengthened glass substrate using a research grade printhead at a deposition temperature between 55° C. and 65° C. A Dimatix® inkjet cartridge configured to deposit with a drop volume 10 pL at a resolution of 1270 dpi was used to form an opaque layer on the glass. The ink was then cured using a UV LED emitting radiation centered at 395 mm.

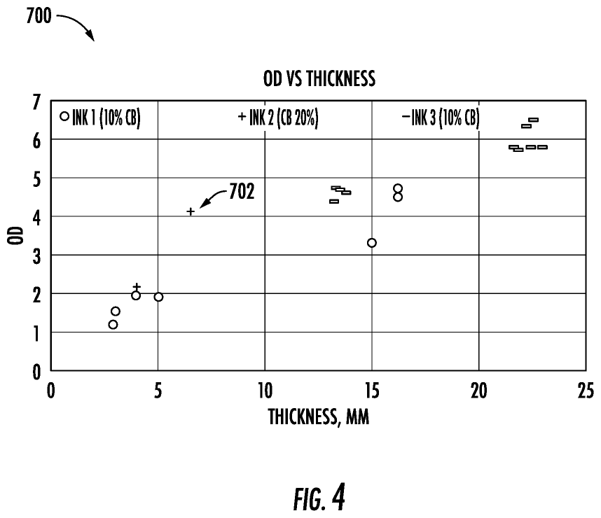

Samples generated according to Examples 1-3 were measured for optical density of the resultant opaque layers using a densitometer. FIG. 4 depicts a chart 700 of optical density as a function of opaque layer thickness for the various samples generated. As demonstrated by the point 702, the opaque layers generated from Example 2 (having the highest wt % of the pigment) resulted in an optical density of greater than 4.0 at thicknesses of less than 8 μm, demonstrating the efficacy of the photocurable inks described herein. Each of the samples represented in FIG. 4 were also tested for adhesion and passed the adhesion test (adhesion of greater than or equal to 4B when measured according to ASTM 3359), when the glass was primed with an acryloxy silane primer prior to the printing.

A sample generated using the ink formulation of Example 1 was subjected to high temperature, high humidity temperature testing by heating the sample to 85° C. in an environment with 95% relative humidity for a period of 500 hours and subsequently tested for adhesion according to ASTM 3359. The results of the cross-hatch adhesion test are depicted in FIG. 5. As shown, the appearance of opaque layer 802 was largely unaffected by the adhesion test, with only small portions of the opaque layer (depicted on the underside of the tape 804 used in the testing) being removed along the incisions. Such results indicate the reliability and durability of the photocurable inks described herein.

### Example 4

Another example was formulated using the composition shown in the Table 6. As shown, the ink formulated according to Example 4 comprised 10 wt % of a carbon black pigment. The ink was jetted onto chemically strengthened glass using a research grade printhead at 60° C. and the printed parts were cured using a UV LED and measured for optical density and thickness. The optical density was measured to be 4.2 at a thickness of 21 μm. The ink passed the adhesion test (with greater than or equal to 4B when measured in accordance with ASTM 3359). Itis believed that higher optical density at lower thickness may be achieved using a pigment dispersion with a more dilute monomer.

TABLE 6

| Component | Wt % |
|---|---|
| UVDJ207 (25% pigment in PONPGDA) | 40 |
| Irgacure 819 | 6 |
| n-vinyl caprolactam | 5 |
| ITX | 3 |
| Omnirad EDB | 3 |
| HPNDA M210 | 22 |
| EMK | 1 |
| DPGDA M222 | 20 |

### Example 5

Another example was formulated using the composition shown in the Table 7. This example differs from the previous example in that the photoinitiator package was modified to maintain cure while reducing the overall percentage in the formulation to give more formulation flexibility. In embodiments, the photoinitiator package is contained in an amount less than or equal to 5 wt. % (e.g., greater than or equal to 2 wt. % and less than or equal to 4.5 wt. %, greater than or equal to 2.5 wt % and less than or equal to 4.0%) to provide formulation flexibility (e.g., to facilitate addition of viscosity modifier). Sun Chemical D3310-FX-K (25% in IBOA) was observed to have a much lower viscosity than UVDJ207 (25% in PONPGDA) and therefore more attractive for inkjet printing. A mixture design of experiments was also used to optimize the formulation for viscosity, printability and overall thickness vs OD. Out of this work it was found that dipropylene glycol diacrylate (DPGDA M222) performed better than hydroxyl pivalic acid neopentyl glycol diacrylate (HPNDA M210), especially when coupled with dipentaerythritol hexaacrylate (DPHA M600) and vinyl methyl oxazolidinone (Vmox). DPHA M600 added additional crosslinking to the ink and helped with cure. Vmox replaced n-vinyl caprolactam as an even better viscosity modifier, while helping with adhesion. As shown in Table 7, the ink formulated according to Example 5 comprised 11.25 wt % of a carbon black pigment. The ink was jetted onto chemically strengthened glass using a production intent KM1024i SHE printhead at 50° C. and the printed parts were cured using a UV LED and measured for optical density and thickness.

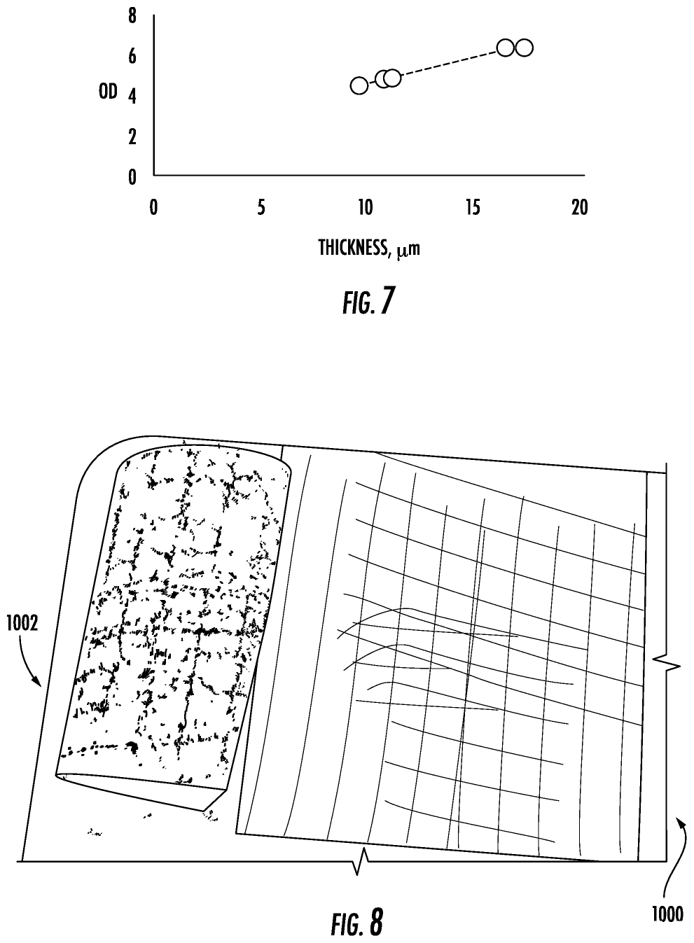

Printed parts were formed using a three-pulse waveform (including a first 10 us pulse at 1V, a second 10 μs pulse at −1 V, and a third 10 μs pulse at 0V) having a total duration of 30 μs. Droplet volume varied from 2.9 pL to 9.0 pL. Droplet velocity varied from 2.67 m/s to 2.86 m/s. Droplet angles varied from 0.21° to 0.60°. FIG. 7 depicts a plot of optical density as a function of thickness for a plurality of samples made in accordance with Example 5. As shown, the formulation provided an optical density of greater than 4.0 for thicknesses greater than 10 μm. For example, the optical density was measured to be 4.8 at a thickness of 11 μm. Example 5 was subjected to high temperature, high humidity temperature testing by heating the sample to 85° C. in an environment with 95% relative humidity for a period of 500 hours and subsequently tested for adhesion according to ASTM 3359. As shown in FIG. 8, the ink passed the adhesion test (with greater than or equal to 4B when measured in accordance with ASTM 3359). The appearance of opaque layer 1000 was largely unaffected by the adhesion test, with only small portions of the opaque layer (depicted on the underside of the tape 1002 used in the testing) being removed along the incisions. Such results indicate the reliability and durability of the photocurable inks described herein.

TABLE 7

| Component | Component Description | Wt % |
|---|---|---|
| D3310-FX-K (25% | Carbon Black Dispersion | 45 |
| pigment in IBOA) | | |
| Irgacure 819 | Photoinitiator | 4 |
| ITX | Photosensitizer | 2 |
| Omnirad EDB | Synergist | 2 |
| Vmox | Viscosity modifier and adhesion aid | 17 |
| DPHA M600 | Multifunctional monomer for cure | 5 |
| | and crosslinking. | |
| DPGDA M222 | Low viscosity difunctional monomer | 25 |
| | to maintain low viscosity while | |
| | maintaining good crosslinking | |

### Counter Examples

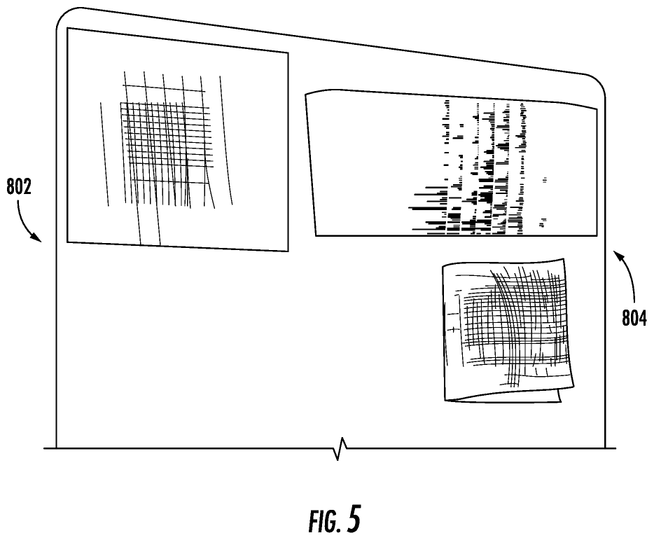

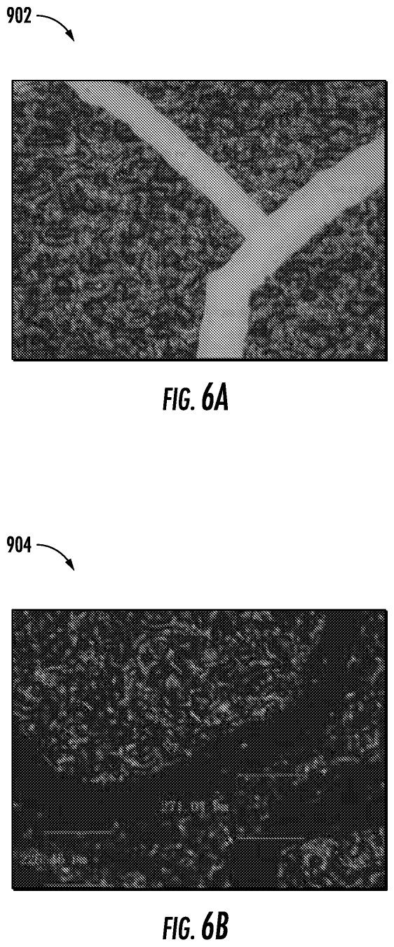

Two commercially available UV-curable inks (Inks A and B) were deposited on pre-primed chemically-strengthened glass and tested under a high temperature, high humidity testing condition (85° C. and 95% relative humidity for 500 hours). FIGS. 6A and 6B depict the samples after the testing. As shown, both samples exhibited visible cracks 902, 904 as a result of shrinkage of the opaque layers. The photocurable inks beneficially do not exhibit visible such visible cracks when subjected to high temperature conditions over long periods, demonstrating the improved durability and reliability of the inks described herein.

### Glass Materials

The various glass layer(s) of the decorated glass discussed herein, such as the substrate 450, may be formed from any suitable glass composition comprising soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may comprise SiO₂ in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition comprises Al₂O₃ in an amount greater than about 4 mol %, or greater than about 5 mol %. In one or more embodiments, the glass composition comprises Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from 9 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, glass layer(s) herein are described as an aluminosilicate glass article or comprising an aluminosilicate glass composition. In such embodiments, the glass composition or article formed therefrom comprises SiO₂ and Al₂O₃ and is not a soda lime silicate glass. In this regard, the glass composition or article formed therefrom comprises Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g., about 0.01 mol % or greater). In one or more embodiments, the glass composition comprises a non-zero amount of P₂O₅ up to and comprising 2 mol %, 1.5 mol %, 1 mol %, or 0.5 mol %. In one or more embodiments, the glass composition is substantially free of P₂O₅.

In one or more embodiments, the glass composition may comprise a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition comprises a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may comprise the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition comprises Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition comprises less than about 4 mol % K₂O, less than about 3 mol % K₂O, or less than about 1 mol % K₂O. In some instances, the glass composition may comprise K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may comprise a total amount of RO (which is the total amount of alkaline earth metal oxide such as CaO, MgO, BaO, ZnO and SrO) in a range from about 0 mol % to about 2 mol %. In some embodiments, the glass composition comprises a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition comprises CaO in an amount less than about 1 mol %, less than about 0.8 mol %, or less than about 0.5 mol %. In one or more embodiments, the glass composition is substantially free of CaO. In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may comprise an oxide that imparts a color or tint to the glass articles. In some embodiments, the glass composition comprises an oxide that prevents discoloration of the glass article when the glass article is exposed to ultraviolet radiation. Examples of such oxides comprise, without limitation oxides of: Ti, V, Cr, Mn, Fe, Co, Ni, Cu, Ce, W, and Mo.

In one or more embodiments, the glass composition comprises Fe expressed as Fe₂O₃, wherein Fe is present in an amount up to (and comprising) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition comprises TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition comprises SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1. 5 mol % to about 6 mol %. Optionally, SnO₂ may be comprised in the amounts otherwise disclosed herein.

### Strengthened Glass Properties

In one or more embodiments, cold-formed glass sheet 2010 or other glass layer of any of the decorated glass embodiments discussed herein may be formed from a strengthened glass sheet or article. In one or more embodiments, the glass articles used to form the layer(s) of the decorated glass structures discussed herein may be strengthened to comprise compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In one or more embodiments, the glass articles used to form the layer(s) of the decorated glass structures discussed herein may be strengthened mechanically by utilizing a mismatch of the coefficient of thermal expansion between portions of the glass to create a compressive stress region and a central region exhibiting a tensile stress. In some embodiments, the glass article may be strengthened thermally by heating the glass to a temperature above the glass transition point and then rapidly quenching.

In one or more embodiments, the glass articles used to form the layer(s) of the decorated glass structures discussed herein may be chemically strengthening by ion exchange. In the ion exchange process, ions at or near the surface of the glass article are replaced by—or exchanged with—larger ions having the same valence or oxidation state. In those embodiments in which the glass article comprises an alkali aluminosilicate glass, ions in the surface layer of the article and the larger ions are monovalent alkali metal cations, such as Li+, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the glass article generate a stress.

Ion exchange processes are typically carried out by immersing a glass article in a molten salt bath (or two or more molten salt baths) containing the larger ions to be exchanged with the smaller ions in the glass article. It should be noted that aqueous salt baths may also be utilized. In addition, the composition of the bath(s) may comprise more than one type of larger ion (e.g., Na+ and K+) or a single larger ion. It will be appreciated by those skilled in the art that parameters for the ion exchange process, comprising, but not limited to, bath composition and temperature, immersion time, the number of immersions of the glass article in a salt bath (or baths), use of multiple salt baths, additional steps such as annealing, washing, and the like, are generally determined by the composition of the glass layer(s) of a decorated glass structure (comprising the structure of the article and any crystalline phases present) and the desired DOC and CS of the glass layer(s) of a decorated glass structure that results from strengthening.

Exemplary molten bath composition may comprise nitrates, sulfates, and chlorides of the larger alkali metal ion. Typical nitrates comprise KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on the glass thickness, bath temperature and glass (or monovalent ion) diffusivity. However, temperatures and immersion times different from those described above may also be used.

In one or more embodiments, the glass articles used to form the layer(s) of the decorated glass may be immersed in a molten salt bath of 100% NaNO₃, 100% KNO₃, or a combination of NaNO₃ and KNO₃ having a temperature from about 370° C. to about 480° C. In some embodiments, the glass layer(s) of a decorated glass may be immersed in a molten mixed salt bath comprising from about 5% to about 90% KNO₃ and from about 10% to about 95% NaNO₃. In one or more embodiments, the glass article may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass articles used to form the layer(s) of the decorated glass structures may be immersed in a molten, mixed salt bath comprising NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass layer(s) of a decorated glass structure. The spike may result in a greater surface CS value. This spike can be achieved by single bath or multiple baths, with the bath(s) having a single composition or mixed composition, due to the unique properties of the glass compositions used in the glass layer(s) of a decorated glass structure described herein.

In one or more embodiments, where more than one monovalent ion is exchanged into the glass articles used to form the layer(s) of the decorated glass structures, the different monovalentions may exchange to different depths within the glass layer (and generate different magnitudes stresses within the glass article at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass article. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from GlasStress Ltd., located in Tallinn Estonia), depending on the strengthening method and conditions. When the glass article is chemically strengthened by an ion exchange treatment, FSM or SCALP may be used depending on which ion is exchanged into the glass article. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM. Central tension or CT is the maximum tensile stress and is measured by SCALP.

In one or more embodiments, the glass articles used to form the layer(s) of the decorated glass structures maybe strengthened to exhibit a DOC that is described a fraction of the thickness t of the glass article (as described herein). For example, in one or more embodiments, the DOC may be equal to or greater than about 0.05t, equal to or greater than about 0.1t, equal to or greater than about 0.11t, equal to or greater than about 0.12t, equal to or greater than about 0.13t, equal to or greater than about 0.14t, equal to or greater than about 0.15t, equal to or greater than about 0.16t, equal to or greater than about 0.17t, equal to or greater than about 0.18t, equal to or greater than about 0.19t, equal to or greater than about 0.2t, equal to or greater than about 0.21t. In some embodiments, The DOC may be in a range from about 0.08t to about 0.25t, from about 0.09t to about 0.25t, from about 0.18t to about 0.25t, from about 0.11t to about 0.25t, from about 0.12t to about 0.25t, from about 0.13t to about 0.25t, from about 0.14t to about 0.25t, from about 0.15t to about 0.25t, from about 0.08t to about 0.24t, from about 0.08t to about 0.23t, from about 0.08t to about 0.22t, from about 0.08t to about 0.21t, from about 0.08t to about 0.2t, from about 0.08t to about 0.19t, from about 0.08t to about 0.18t, from about 0.08t to about 0.17t, from about 0.08t to about 0.16t, or from about 0.08t to about 0.15t. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

In one or more embodiments, the glass articles used to form the layer(s) of the decorated glass structures may have a CS (which may be found at the surface or a depth within the glass article) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the glass articles used to form the layer(s) of the decorated glass structures may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa.

Embodiments of the present disclosure may be further understood in view of the following aspects:

An aspect (1) pertains to a glass article comprising: a glass substrate having a first major surface and a second major surface, the second major surface being opposite the first major surface; and an opaque layer disposed on the second major surface, the opaque layer comprising a photocurable ink comprising at least 10 wt % of a pigment, wherein: the opaque layer comprises a thickness of less than or equal to 25 μm and an optical density of greater than or equal to 4.0, and after curing via exposure to curing light from an ultraviolet light (“UV”) light emitting diode (“LED”), the opaque layer exhibits: a pencil hardness of greater than or equal to 3H when measured according to ASTM 3363, and an adhesion to the glass substrate of greater than or equal to 4B after being subjected to a temperature of 85° C. at 95% relative humidity for a period of at least 500 hours, when tested according to ASTM 3359.

An aspect (2) of the present disclosure pertains to a glass article according to the aspect (1), wherein the photocurable ink comprises at least 30 wt % of a pigment dispersion, the pigment dispersion comprising greater than or equal to 25 wt % of the pigment and a reactive monomer.

An aspect (3) of the present disclosure pertains to a glass article according to the aspect (2), wherein the pigment dispersion comprises greater than or equal to 40 wt % of the pigment.

An aspect (4) of the present disclosure pertains to a glass article according to the any of the aspects (1)-(3), wherein the thickness is less than or equal to 10 μm.

An aspect (5) of the present disclosure pertains to a glass article according to any of the aspects (1)-(4), wherein the photocurable ink is free of halogenated hydrocarbon, etheylbenzene, propylene oxide, styrene, benzene, isopropyl nitrite, butyl nitrite, ethylene glycol monoethyl ether, etheneglycol monomethyl ether, ethylene glycol formaldehyde acetate, 2-nitropropane, 2-methyl-2-pyrrolidone, triethylene glycol dimethyl ether, ethylene glycol dimethyl ether, ethylene glycol diethyl either, toluene, and xylene.

An aspect (6) of the present disclosure pertains to a glass article according to any of the aspects (1)-(5), wherein the pigment comprises an average particle size of less than or equal to 200 nm.

An aspect (7) of the present disclosure pertains to a glass article according to any of the aspects (1)-(6), wherein the opaque layer exhibits a cured surface tension of greater than 36 dynes/cm.

An aspect (8) of the present disclosure pertains to a glass article according to any of the aspects (1)-(7), wherein the opaque layer exhibits an electrical resistivity of greater than or equal to 1×10⁹ Ω/sq, when measured according to ASTMD-257 at 100V DC.

An aspect (9) of the present disclosure pertains to a glass article any of the aspects (1)-(8), wherein the glass article exhibits a CIELAB SCI L* value that is less than or equal to 30 when illuminated at a 10° angle by a D65 illuminant.

An aspect (10) of the present disclosure pertains to a glass article according to any of the aspects (1)-(9), wherein the glass article exhibits a CIELAB SCI a* value that is greater than or equal to −0.05 and less than or equal to 0.15 and a CIELAB SCI b* value that is greater than or equal to −0.3 and less than or equal to −0.1 when illuminated at a 10° angle by a D65 illuminant.

An aspect (11) of the present disclosure pertains to a glass article according to any of the aspects (1)-(10), further comprising a light management layer disposed on the second major surface between the glass substrate and the opaque layer, wherein the light management layer is formed of an ink and comprises an average optical transmission of less than or equal to 70% from 380 nm to 750 nm.

An aspect (12) of the present disclosure pertains to a glass article according to any of the aspects (1)-(11), wherein the glass substrate comprises at least one of soda lime glass, aluminosilicate glass, borosilicate glass, boroaluminosilicate glass, alkali-containing aluminosilicate glass, or alkali-containing borosilicate glass.

An aspect (13) of the present disclosure pertains to a display for a vehicle interior system, the display comprising: a glass substrate having a first major surface and a second major surface, the second major surface being opposite the first major surface; an opaque layer disposed on the second major surface, the opaque layer comprising a photocurable ink comprising at least 10 wt % of a pigment; and a display panel disposed on the second major surface, wherein: the opaque layer is disposed at a peripheral region of the second major surface and extends over an edge of the display panel, the opaque layer comprises a thickness of less than or equal to 25 μm and an optical density of greater than or equal to 4.0, and after curing via exposure to curing light from an ultraviolet light (“UV”) light emitting diode (“LED”), the opaque layer exhibits: a pencil hardness of greater than or equal to 3H when measured according to ASTM 3363, and an adhesion to the glass substrate of greater than or equal to 4B when subjected to a temperature of 85° C. at 95% relative humidity for a period of at least 500 hours, when tested according to ASTM 3359.

An aspect (14) of the present disclosure pertains to a display according to the aspect (14), wherein the photocurable ink comprises at least 30 wt % of a pigment dispersion, the pigment dispersion comprising greater than or equal to 25 wt % of the pigment and a reactive monomer.

An aspect (15) of the present disclosure pertains to a display according to any of the aspects (13)-(14), wherein the thickness is less than or equal to 10 μm.

An aspect (16) of the present disclosure pertains to a display according to any of the aspects (13)-(15), wherein the photocurable ink is free of halogenated hydrocarbon, etheylbenzene, propylene oxide, styrene, benzene, isopropyl nitrite, butyl nitrite, ethylene glycol monoethyl ether, etheneglycol monomethyl ether, ethylene glycol formaldehyde acetate, 2-nitropropane, 2-methyl-2-pyrrolidone, triethylene glycol dimethyl ether, ethylene glycol dimethyl ether, ethylene glycol diethyl either, toluene, and xylene.

An aspect (17) of the present disclosure pertains to a display according to any of the aspects (13)-(16), wherein the pigment comprises an average particle size of less than or equal to 200 nm.

An aspect (18) of the present disclosure pertains to a display according to any of the aspects (13)-(17), wherein the display exhibits a CIELAB SCI L* value that is less than or equal to 30 when illuminated at a 10° angle by a D65 illuminant.

An aspect (19) of the present disclosure pertains to a display according to any of the aspects (13)-(18), wherein the display exhibits a CIELAB SCI a* value that is greater than or equal to −0.05 and less than or equal to 0.15 and a CIELAB SCI b* value that is greater than or equal to −0.3 and less than or equal to −0.1 when illuminated at a 10° angle by a D65 illuminant.

An aspect (20) of the present disclosure pertains to a display according to any of the aspects (13)-(19), further comprising a light management layer disposed on the second major surface between the glass substrate and the opaque layer, wherein the light management layer is formed of an ink and comprises an average optical transmission of less than or equal to 70% from 380 nm to 750 nm.

An aspect (21) pertains to a method of fabricating a glass article, the method comprising: depositing a photocurable ink onto a major surface of a glass substrate at a deposition temperature that is less than or equal to 65° C. using an inkjet printhead, wherein during the depositing, the photocurable ink has a viscosity of less than 25 cP, wherein the photocurable ink comprises at least 10 wt % of a pigment and at least 50 wt % reactive monomer, and curing the photocurable ink on the major surface by exposing the photocurable ink to curing light generated by a ultraviolet light (“UV”) light emitting diode (“LED”) to form an opaque layer, wherein the curing light has a bandwidth of less than or equal to 30 nm, wherein: the opaque layer comprises a thickness of less than or equal to 25 μm and an optical density of greater than or equal to 4.0, and the opaque layer exhibits: a pencil hardness of greater than or equal to 3H when measured according to ASTM 3363, and an adhesion to the glass substrate of greater than or equal to 4B when subjected to a temperature of 85° C. at 95% relative humidity for a period of at least 500 hours, when tested according to ASTM 3359.

An aspect (22) pertains to a method according to the aspect (21), further comprising priming the major surface of the glass substrate with an acryloxy silane primer prior to depositing the photocurable ink.

An aspect (23) pertains to a method according to any of the aspects (21)-(22), wherein the opaque layer covers a peripheral portion of the major surface such that the glass article exhibits a higher optical transmission from 380 nm to 750 nm in a central region not including the opaque layer.

An aspect (24) pertains to a method according to any of the aspects (21)-(23), wherein the photocurable ink is free of halogenated hydrocarbon, etheylbenzene, propylene oxide, styrene, benzene, isopropyl nitrite, butyl nitrite, ethylene glycol monoethyl ether, ethene glycol monomethyl ether, ethylene glycol formaldehyde acetate, 2-nitropropane, 2-methyl-2-pyrrolidone, triethylene glycol dimethyl ether, ethylene glycol dimethyl ether, ethylene glycol diethyl either, toluene, and xylene.

An aspect (25) pertains to a method according to any of the aspects (21)-(24), further comprising performing one or more additional surface treatments on an additional major surface of the glass substrate, the one or more additional surface treatments comprising at least one of chemically etching the additional major surface such that the additional major surface exhibits antiglare properties and depositing an anti-reflective coating onto the additional major surface.

An aspect (26) pertains to a method according to any of the aspects (21)-(25), further comprising, prior to depositing the photocurable ink, depositing a light management layer onto the major surface, the light management layer comprising an ink that is different in composition from the photocurable ink and at least partially overlapping the opaque layer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to comprise one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to comprise everything within the scope of the appended claims and their equivalents.

1. A glass article comprising:
a glass substrate having a first major surface and a second major surface, the second major surface being opposite the first major surface; and
an opaque layer disposed on the second major surface, the opaque layer comprising a photocurable ink comprising at least 10 wt % of a pigment, wherein:
the opaque layer comprises a thickness of less than or equal to 25 μm and an optical density of greater than or equal to 4.0, and
after curing via exposure to curing light from an ultraviolet light (“UV”) light emitting diode (“LED”), the opaque layer exhibits:
a pencil hardness of greater than or equal to 3H when measured according to ASTM 3363, and
an adhesion to the glass substrate of greater than or equal to 4B after being subjected to a temperature of 85° C. at 95% relative humidity for a period of at least 500 hours, when tested according to ASTM 3359.

2. (canceled)

3. (canceled)

4. The glass article of claim 1, wherein the thickness is less than or equal to 10 μm.

5. The glass article of claim 1, wherein the photocurable ink is free of halogenated hydrocarbon, etheylbenzene, propylene oxide, styrene, benzene, isopropyl nitrite, butyl nitrite, ethylene glycol monoethyl ether, ethene glycol monomethyl ether, ethylene glycol formaldehyde acetate, 2-nitropropane, 2-methyl-2-pyrrolidone, triethylene glycol dimethyl ether, ethylene glycol dimethyl ether, ethylene glycol diethyl either, toluene, and xylene.

6. The glass article of claim 1, wherein the pigment comprises an average particle size of less than or equal to 200 nm.

7. The glass article of claim 1, wherein the opaque layer exhibits a cured surface tension of greater than 36 dynes/cm.

8. The glass article of claim 1, wherein the opaque layer exhibits an electrical resistivity of greater than or equal to 1×10⁹ Ω/sq, when measured according to ASTM D-257 at 100V DC.

9. The glass article of claim 1, wherein the glass article exhibits a CIELAB SCI L* value that is less than or equal to 30 when illuminated at a 10° angle by a D65 illuminant.

10. The glass article of claim 1, wherein the glass article exhibits a CIELAB SCI a value that is greater than or equal to −0.05 and less than or equal to 0.15 and a CIELAB SCI b* value that is greater than or equal to −0.3 and less than or equal to −0.1 when illuminated at a 10° angle by a D65 illuminant.

11. (canceled)

12. (canceled)

13. A display for a vehicle interior system, the display comprising:
a glass substrate having a first major surface and a second major surface, the second major surface being opposite the first major surface;
an opaque layer disposed on the second major surface, the opaque layer comprising a photocurable ink comprising at least 10 wt % of a pigment; and
a display panel disposed on the second major surface, wherein:
the opaque layer is disposed at a peripheral region of the second major surface and extends over an edge of the display panel,
the opaque layer comprises a thickness of less than or equal to 25 μm and an optical density of greater than or equal to 4.0, and
after curing via exposure to curing light from an ultraviolet light (“UV”) light emitting diode (“LED”), the opaque layer exhibits:
a pencil hardness of greater than or equal to 3H when measured according to ASTM 3363, and
an adhesion to the glass substrate of greater than or equal to 4B when subjected to a temperature of 85° C. at 95% relative humidity for a period of at least 500 hours, when tested according to ASTM 3359.

14. (canceled)

15. The display of claim 13, wherein the thickness is less than or equal to 10 μm.

16. The display of claim 13, wherein the photocurable ink is free of halogenated hydrocarbon, etheylbenzene, propylene oxide, styrene, benzene, isopropyl nitrite, butyl nitrite, ethylene glycol monoethyl ether, ethene glycol monomethyl ether, ethylene glycol formaldehyde acetate, 2-nitropropane, 2-methyl-2-pyrrolidone, triethylene glycol dimethyl ether, ethylene glycol dimethyl ether, ethylene glycol diethyl either, toluene, and xylene.

17. The display of claim 13, wherein the pigment comprises an average particle size of less than or equal to 200 nm.

18. The display of claim 13, wherein the display exhibits a CIELAB SCI L* value that is less than or equal to 30 when illuminated at a 10° angle by a D65 illuminant, wherein the display exhibits a CIELAB SCI as value that is greater than or equal to −0.05 and less than or equal to 0.15 and a CIELAB SCI b* value that is greater than or equal to −0.3 and less than or equal to −0.1 when illuminated at a 10° angle by a D65 illuminant.

19. (canceled)

20. The display of claim 13, further comprising a light management layer disposed on the second major surface between the glass substrate and the opaque layer, wherein the light management layer is formed of an ink and comprises an average optical transmission of less than or equal to 70% from 380 nm to 750 nm.

21. A method of fabricating a glass article, the method comprising:
depositing a photocurable ink onto a major surface of a glass substrate at a deposition temperature that is less than or equal to 65° C. using an inkjet printhead, wherein during the depositing, the photocurable ink has a viscosity of less than 25 cP, wherein the photocurable ink comprises at least 10 wt % of a pigment and at least 50 wt % reactive monomer; and
curing the photocurable ink on the major surface by exposing the photocurable ink to curing light generated by an ultraviolet light (“UV”) light emitting diode (“LED”) to form an opaque layer, wherein the curing light has a bandwidth of less than or equal to 30 nm, wherein:
the opaque layer comprises a thickness of less than or equal to 25 μm and an optical density of greater than or equal to 4.0, and
the opaque layer exhibits:
a pencil hardness of greater than or equal to 3H when measured according to ASTM 3363, and
an adhesion to the glass substrate of greater than or equal to 4B when subjected to a temperature of 85° C. at 95% relative humidity for a period of at least 500 hours, when tested according to ASTM 3359.

22. The method of claim 21, further comprising priming the major surface of the glass substrate with an acryloxy silane primer prior to depositing the photocurable ink.

23. The method of claim 21, wherein the opaque layer covers a peripheral portion of the major surface such that the glass article exhibits a higher optical transmission from 380 nm to 750 nm in a central region not including the opaque layer.

24. The method of claim 21, wherein the photocurable ink is free of halogenated hydrocarbon, etheylbenzene, propylene oxide, styrene, benzene, isopropyl nitrite, butyl nitrite, ethylene glycol monoethyl ether, ethene glycol monomethyl ether, ethylene glycol formaldehyde acetate, 2-nitropropane, 2-methyl-2-pyrrolidone, triethylene glycol dimethyl ether, ethylene glycol dimethyl ether, ethylene glycol diethyl either, toluene, and xylene.

25. The method of claim 21, further comprising performing one or more additional surface treatments on an additional major surface of the glass substrate, the one or more additional surface treatments comprising at least one of chemically etching the additional major surface such that the additional major surface exhibits antiglare properties and depositing an anti-reflective coating onto the additional major surface.

26. The method of claim 21, further comprising, prior to depositing the photocurable ink, depositing a light management layer onto the major surface, the light management layer comprising an ink that is different in composition from the photocurable ink and at least partially overlapping the opaque layer.
